(19) United States
(12) Patent Application Publication
(10) Pub. No.: US 2011/0089075 A1
(43) Pub. Date: Apr. 21, 2011

(54) METHOD FOR COATING GLASS, POLYETHYLENE OR POLYESTER CONTAINERS, AND SUITABLE AQUEOUS FORMULATIONS FOR SAID COATING METHOD

(75) Inventors: Heike Pfistner, Ludwigshafen (DE); Hartmut Leininger, Neustadt (DE); Bernd Düttra, Hassloch (DE); Petra Neumann, Bohl-Iggelheim (DE); Nicole Klöden, Ludwigshafen (DE)

(73) Assignee: BASF SE, Ludwigshafen (DE)

(21) Appl. No.: 12/992,391

(22) PCT Filed: May 11, 2009
(86) PCT No.: PCT/EP2009/055637

§ 371 Date: Nov. 12, 2010

(30) Foreign Application Priority Data
May 14, 2008 (EP) 08156172.2

(51) Int. Cl. B65D 79/00; B05D 1/18; B05D 1/02; B32B 1/02; C09D 191/06

(52) U.S. Cl. 206/524.3; 427/443; 427/427.4; 428/35.7; 106/271

(57) ABSTRACT

A method of coating containers made of glass, polyethylene or polyester by treatment with a substantially paraffin-free aqueous formulation comprising
(A) at least one acid-functional waxy copolymer selected from
   (A1) partially oxidized polyethylene waxes having an acid number in the range from 10 to 100 mg KOH/g, determined in accordance with DIN 53402, with
   (A2) copolymers having a melt flow rate (MFR) in the range from 1 to 50 g/10 min, measured at 160° C. under a load of 325 g in accordance with EN ISO 1133, which in copolymerized form comprise
      (a) 60% to 88% by weight of ethylene,
      (b) 12% to 40% by weight of at least one ethylenically unsaturated carboxylic acid,
   and which are at least partially neutralized with alkali metal or amine,
(B) if desired, at least one nonionic or anionic surfactant,
(C) if desired, at least one defoamer,
(D) if desired, at least one organic amine,
(E) if desired, at least one organic solvent.

The present invention relates to a method of coating containers made of glass, polyethylene or polyester by treatment with at least one substantially paraffin-free aqueous formulation comprising

(A) at least one acid-functional waxy copolymer selected from
(A1) partially oxidized polyethylene waxes having an acid number in the range from 10 to 100 mg KOH/g, determined in accordance with DIN 53402, and
(A2) copolymers having a melt flow rate (MFR) in the range from 1 to 50 g/10 min, measured at 160° C. under a load of 325 g in accordance with EN ISO 1133, which in copolymerized form comprise
   (a) 60% to 88% by weight of ethylene,
   (b) 12% to 40% by weight of at least one ethylenically unsaturated carboxylic acid,
   and which are at least partially neutralized with alkali metal or amine,
      (B) if desired, at least one nonionic or anionic surfactant,
      (C) if desired, at least one defoamer,
      (D) if desired, at least one organic amine,
      (E) if desired, at least one organic solvent,
      (F) if desired, a polymer dispersion.

Additionally the present invention relates to containers coated by the method of the invention. Additionally the present invention relates to aqueous formulations which are especially suitable for implementing the method of the invention.

Numerous liquids, more particularly beverages, are nowadays sold in transparent containers made of glass, polyethylene or polyester. Glass and polyesters as well, more particularly PET (polyethylene terephthalate), have numerous advantages. They have a certain mechanical stability; they do not greatly interfere with the taste of beverages; in the case of glass more particularly they are also highly suitable for transporting carbonated beverages; and they are established on the market. Also established is a return system, and the deposit rate of bottles is at present quite good. After being cleaned, they can generally be used again without hygiene concerns.

It is nevertheless observed that containers made of glass, polyethylene or polyester, after being used a number of times, exhibit disadvantageous differences from new containers made of glass, polyethylene or polyester: scratches, small delaminations, and clouding detract from the transparency and hence from the esthetics. Furthermore, multiply used containers of glass, polyethylene or polyester have an “old” feel.

In the selection of the coating material, in connection with surfaces, it is usual to recommend paraffins. In order for paraffins to be applied to surfaces, it would be convenient to formulate them in water and then apply them. What are needed, therefore, are one or more surface-active substances (emulsifiers, surfactants), to allow the paraffin to be formulated.

Paraffins, however, have disadvantages when used for the temporary coating of surfaces. The activity of paraffinic coatings is generally for one day or less and is hence too short for containers of glass, polyethylene or polyester. Furthermore, for containers of glass, polyethylene or polyester, the stated coatings are generally too tacky. Furthermore, paraffinic coatings frequently tend to smear and are therefore unacceptable for coatings where cleanliness is a requirement, such as for the containers identified above, for example.

Numerous other coatings which have the advantage of greater durability than coatings with paraffin are difficult to remove in the event of soiling, requiring removal, for example, by means of strongly alkaline cleaning solutions. However, if glass, polyethylene or polyester is treated with strongly alkaline cleaning solutions, glass or polyester is severely attacked.

The object was therefore to provide a method of coating containers made of glass, polyethylene or polyester that ensures effective temporary protection, that gives even scratched containers of glass, polyethylene or polyester a pleasing appearance and an appealing exterior in terms not least of feel, and which ensures, furthermore, that the coating is easily removable. A further object was to provide temporarily coated containers made of glass, polyethylene or polyester. A further object was to provide formulations with which the method of the invention can be performed effectively, and to provide a method of preparing such formulations.

Accordingly the method defined at the outset has been found.

By containers are meant, for example, packaging and other containers of any desired form, preferably dishes, canisters, pots, and bottles, preferably bottles. Containers for comestibles are particularly preferred. These include beverage bottles, cream pots, jars for pickles or yogurt, but with particular preference beverage bottles for carbonated beverages.

Containers for coating in accordance with the invention are made of glass, polyethylene or polyester, with polyethylene denoting more particularly polyethylene produced by the low-pressure process, in other words, for example, using a Ziegler-Natta catalyst, and with polyester comprising, more particularly, polyethylene terephthalate (PET). Containers produced from glass-coated polyethylene terephthalate or from glass-coated polyethylene are also comprised.

Containers of glass, polyethylene or polyester are preferably those having a wall thickness of at least half a millimeter up to 5 mm. Containers of glass, polyethylene or polyester are preferably those having a wall thickness of up to 5 mm.

In one embodiment of the present invention the containers of glass, polyethylene or polyester are multiple-use containers, such as bottles with a deposit, for example.

In another embodiment of the present invention, polyester containers are those which have been melted following single use, the melt has been admixed with a chain extender, and the additized melt has been reprocessed to a container by renewed blow molding.

In one embodiment of the present invention, containers of glass, polyethylene or polyester can be cleaned by conventional methods prior to the actual coating of the invention.

The method of the invention is carried out by coating containers of glass, polyethylene or polyester with a substantially paraffin-free aqueous formulation which comprises:
(A) at least one acid-functional waxy copolymer selected from
   (A1) partially oxidized polyethylene waxes having an acid number in the range from 10 to 100 mg KOH/g, determined in accordance with DIN 53402, and
   (A2) copolymers having a melt flow rate (MFR) in the range from 1 to 50 g/10 min, measured at 160° C. under a load of 325 g in accordance with EN ISO 1133, which in copolymerized form comprise
      (a) 60% to 88% by weight of ethylene,
      (b) 12% to 40% by weight of at least one ethylenically unsaturated carboxylic acid,
   and which are at least partially neutralized with alkali metal or amine,
(B) if desired, at least one nonionic or anionic surfactant,
(C) if desired, at least one defoamer,
(D) if desired, at least one organic amine,
(E) if desired, at least one organic solvent,
(F) if desired, a polymer dispersion.

Aqueous formulations used in the coating method of the invention are substantially paraffin-free. By paraffin-free is meant that in the method of the invention, which in the context of the present invention is also called the coating method of the invention, aqueous formulations employed comprise not more than 0.5% by weight of paraffin, preferably not more than 0.1% by weight of paraffin, relative to the solids content of the aqueous formulation in question, in other words to the sum of the constituents (A), (B), (C), and, where used, (D) and/or (F). Paraffins for the purposes of the present invention also comprise white oil.

Aqueous dispersions used in the coating method of the invention, furthermore, are preferably substantially silicone oil-free. By silicone oil-free is meant that aqueous formulations used in the coating method of the invention comprise not more than 0.5% by weight of silicone oil, preferably not more than 0.1% by weight of silicone oil, relative to the solids content of the aqueous formulation in question, in other words to the sum of the constituents (A), (B), (C), and, where used, (D) and/or (F).

Aqueous formulations used in the coating method of the invention comprise at least one acid-functional waxy copolymer, also referred to for short as copolymer (A), which is selected from
(A1) partially oxidized polyethylene waxes having an acid number in the range from 10 to 100 mg KOH/g, preferably 10 to 50 mg KOH/g, determined in accordance with DIN 53402, and
(A2) copolymers having a melt flow rate (MFR) in the range from 1 to 50 g/10 min, preferably 5 to 20 g/10 min, more preferably 7 to 15 g/10 min, measured at 160° C. under a load of 325 g in accordance with EN ISO 1133, which in copolymerized form comprise
(a) 60% to 88%, preferably 65% to 80%, by weight of ethylene,
(b) 12% to 40%, preferably 20% to 35%, by weight of at least one ethylenically unsaturated carboxylic acid,
and which are at least partially neutralized with alkali metal, more particularly with potassium or sodium, or with amine, more particularly ammonia or ω-hydroxyalkylamine,
   amounts in % by weight being based on the copolymer (A2) as a whole.

By at least partially neutralized here is meant that at least 33 mol % of all the carboxylic acid groups of copolymer (A) are neutralized with alkali metal or amine.

In one embodiment of the present invention in the region of 50 to 99 mol % of all of the carboxylic acid groups of copolymer (A) are neutralized with alkali metal or amine. In one specific embodiment of the present invention all the carboxylic acid groups of copolymer (A) are neutralized with alkali metal or amine.

Partially oxidized polyethylene waxes having an acid number in the range from 10 to 100 mg KOH/g, preferably 15 to 50 mg KOH/g, determined in accordance with DIN 53402, are also identified in the context of the present invention as copolymer (A1) and will be described briefly below. Copolymer (A1) is at least partially neutralized with alkali metal, more particularly with potassium or sodium, or with amine, more particularly ammonia or ω-hydroxyalkylamine.

Copolymer (A1) can be prepared by conventional methods. It is possible, for example, first to prepare a polyethylene which has an average molecular weight Mₙ of up to not more than 20 000 g/mol, and then to subject this polyethylene in the melted state to partial oxidation with oxygen or oxygenous gas, more particularly with air, until the desired acid number is reached. Suitable reactors for such partial oxidations are tube reactors and bubble-column reactors, of the kind known, for example, from “Ullmanns Enzyklopädie der technischen Chemie”, 4th edition, Verlag Chemie, Weinheim, Volume 3, p. 369.

The polyethylene in question may be prepared by various methods, as for example in the high-pressure process or in the low-pressure process. The expression “high-pressure process” identifies processes which are carried out at a pressure in the range from 1500 to 3500 bar and at temperatures in the range from 200 to 350°. The high-pressure process in this context relates to a free-radical addition polymerization which can be initiated, for example, by oxygen or by a peroxide. The expression “low-pressure process”, in contrast, identifies catalytically implemented polymerizations which are carried out, for example, with a Ziegler-Natta catalyst, a Cr catalyst or a metallocene catalyst. The low-pressure process can be carried out, for example, at a pressure in the range from 30 to 100 bar, suitable temperature ranges being 50 to 100° C. In another version it is possible to use a polyethylene which is prepared using a polymerization catalyst at 500 to 900 bar.

The expression “polyethylene” is not confined to homopolymers of ethylene, but instead also comprises, for example, copolymers of ethylene with one or more α-olefins such as, for example, propylene, 1-butene, 1-pentene, 1-hexene, 1-octene, 1-decene or 1-dodecene, additionally with other olefins such as isobutene, and also with ethylenically unsaturated monocarboxylic or dicarboxylic acids, more particularly with (meth)acrylic acid.

In one embodiment of the present invention copolymer (A1) has a hydrolysis number in the range from 10 to 70 mg KOH/g, determined in accordance with DIN 53401.

In one embodiment of the present invention copolymer (A1) has a density in the range from 0.95 to 0.99 g/cm³.

Copolymers having a melt flow rate (MFR) in the range from 1 to 50 g/10 min, measured at 160° C. under a load of 325 g in accordance with EN ISO 1133, and in copolymerized form comprising the aforementioned fractions of ethylene (a) and ethylenically unsaturated carboxylic acid (b), are also referred to in the context of the present invention as copolymer (A2) and will be described briefly below. Copolymer (A2) is at least partially neutralized with alkali metal, more particularly with potassium or sodium, or with amine, more particularly ammonia or ω-hydroxyalkylamine.

Suitable ethylenically unsaturated carboxylic acid includes, more particularly, C₃-C₁₂ monocarboxylic and C₄-C₁₂ dicarboxylic acids which contain at least one C—C double bond, or the low molecular mass anhydrides of the corresponding C₄-C₁₂ dicarboxylic acids.

As ethylenically unsaturated carboxylic acid (a) it is preferred to select at least one carboxylic acid of the general formula I

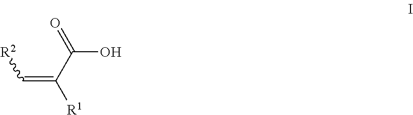

in which the variables are defined as follows:
R¹ and R² are alike or different.
R¹ is selected from hydrogen and unbranched and branched C₁-C₁₀ alkyl, such as methyl, ethyl, n-propyl, isopropyl, n-butyl, isobutyl, sec-butyl, tert-butyl, n-pentyl, iso-pentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl, for example; more preferably C₁-C₄alkyl such as methyl, ethyl, n-propyl, isopropyl, n-butyl, isobutyl, sec-butyl, and tert-butyl, and more particularly methyl;
R² is selected from unbranched and branched C₁-C₁₀ alkyl such as, for example, methyl, ethyl, n-propyl, isopropyl, n-butyl, isobutyl, sec-butyl, tert-butyl, n-pentyl, iso-pentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; preferably C₁-C₄ alkyl such as methyl, ethyl, n-propyl, isopropyl, n-butyl, isobutyl, sec-butyl and tert-butyl, and more particularly methyl;

### COOH,

and, with very particular preference, hydrogen.

In one embodiment of the present invention R¹ is hydrogen or methyl. With very particular preference R¹ is methyl.

In one embodiment of the present invention R¹ is hydrogen or methyl and R² is hydrogen.

Very particular preference is given to using methacrylic acid as the ethylenically unsaturated C₃-C₁₂ carboxylic acid of the general formula I.

Preferred examples of C₄-C₁₂ dicarboxylic acids are fumaric acid, maleic acid, methylenemalonic acid, itaconic acid, citraconic acid, methaconic acid, more preferably maleic acid, and also their low molecular mass anhydrides, more particularly maleic anhydride.

If it is desired to use a copolymer (A2) which in copolymerized form comprises two or more ethylenically unsaturated carboxylic acids (a), then it is possible, for example, to use two different ethylenically unsaturated carboxylic acids of the general formula I, such as acrylic acid and methacrylic acid, for example. In that case the percentages are based on the overall fraction of ethylenically unsaturated carboxylic acids (a).

In one embodiment it is possible for copolymer (A2) in copolymerized form to comprise one or more further comonomers (c), examples being vinyl acetate, vinyl propionate, styrene or one or more ethylenically unsaturated C₃-C₁₀ carboxylic acid C₁-C₁₀ alkyl esters, more particularly methyl acrylate, methyl methacrylate, n-butyl acrylate, ethyl acrylate, ethyl methacrylate, glycidyl (meth)acrylate, and additionally isobutene and C₁₆-C₃₀ α-olefin.

If copolymer (A2) in copolymerized form comprises one or more comonomers (c), then the fraction of comonomers (c) can be 0.1 to 20% by weight, based on the sum of copolymerized ethylene (a) and copolymerized ethylenically unsaturated carboxylic acid (b).

In another embodiment of the present invention copolymer (A2) in copolymerized form comprises no further comonomers other than ethylene (a) and ethylenically unsaturated carboxylic acid (b).

In one embodiment of the present invention the acid number of copolymer (A2) is 100 to 300 mg KOH/g, preferably 115 to 230 mg KOH/g, determined in accordance with DIN 53402.

In one version of the present invention copolymer (A2) has a kinematic melt viscosity v of at least 45 000 mm²/s, preferably of at least 50 000 mm²/s, determined at 120° C.

In one version of the present invention copolymer (A1) has a kinematic melt viscosity v in the region of at least 5000 mm²/s, preferably of at least 50 000 mm²/s, determined at 120° C.

In one embodiment of the present invention copolymer (A) has a molecular weight Mₙ in the range from 10 000 to 20 000 g/mol, determined by gel permeation chromatography (GPC).

In one version of the present invention copolymer (A) has a molecular weight Mₙ in the range from 10 000 to 100 000 g/mol, determined by gel permeation chromatography (GPC).

In one embodiment of the present invention the melting range of copolymer (A1) or more particularly (A2) is in the range from 60 to 110° C., preferably in the range from 65 to 90° C., determined by DSC (differential thermal analysis) in accordance with DIN 51007.

In one version of the present invention the melting range of copolymer (A2) is in the range from 100 to 140° C., determined in accordance with DIN 51007.

Copolymer (A) can be prepared advantageously by free-radically initiated copolymerization under high-pressure conditions, as for example in stirred high-pressure autoclaves or in high-pressure tube reactors. Preparation in stirred high-pressure autoclaves is preferred. Stirred high-pressure autoclaves are known per se; a description is given in Ullmann's Encyclopedia of Industrial Chemistry, 5th edition, heading: Waxes, Vol. A 28, p. 146 ff., Verlag Chemie Weinheim, Basel, Cambridge, N.Y., Tokyo, 1996. In such reactors, the length/diameter ratio is predominantly within ranges of 5:1 to 30:1, preferably 10:1 to 20:1. The high-pressure tube reactors that can likewise be employed are likewise found in Ullmann's Encyclopedia of Industrial Chemistry 5th edition, heading: Waxes, Vol. A 28, p. 146 ff., Verlag Chemie Weinheim, Basel, Cambridge, N.Y., Tokyo, 1996.

Suitable pressure conditions for the polymerization are 500 to 4000 bar, preferably 1500 to 2500 bar. Conditions of this kind are also referred to below as high pressure. The reaction temperatures are in the range from 170 to 300° C., preferably in the range from 195 to 280° C.

The polymerization can be carried out advantageously in the presence of a regulator. A regulator used is, for example, hydrogen or at least one aliphatic aldehyde or at least one aliphatic ketone of the general formula II

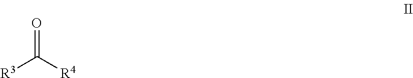

or mixtures thereof.

In that formula the radicals R³ and R⁴ are alike or different and are selected from hydrogen;

C₁-C₆ alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, more preferably C₁-C₄ alkyl such as methyl, ethyl, n-propyl, iso-propyl, n-butyl, isobutyl, sec-butyl, and tert-butyl;
C₃-C₁₂ Cycloalkyl such as cyclopropyl, cyclobutyl, cyclopentyl, cyclohexyl, cycloheptyl, cyclooctyl, cyclononyl, cyclodecyl, cycloundecyl, and cyclododecyl; cyclopentyl, cyclohexyl, and cycloheptyl are preferred.

In one particular embodiment the radicals R³ and R⁴ are joined covalently to one another to form a 4- to 13-membered ring. Thus R³ and R⁴ together may be, for example: —(CH₂)₄—, —(CH₂)₅—, —(CH₂)₆, —(CH₂)₇—, —CH(CH₃)—CH₂—CH₂—CH(CH₃)— or —CH(CH₃)—CH₂—CH₂—CH₂—CH(CH₃)—.

Further examples of suitable regulators are alkylaromatic compounds, examples being toluene, ethylbenzene or one or more isomers of xylene. Examples of highly suitable regulators are, in addition, paraffins such as, for example, isododecane (2,2,4,6,6-pentamethylheptane) or isooctane.

As initiators for the free-radical polymerization it is possible to use the typical free-radical initiators such as organic peroxides, oxygen or azo compounds, for example. Mixtures of two or more free-radical initiators are also suitable.

Suitable peroxides, selected from substances available commercially, are didecanoyl peroxide, 2,5-dimethyl-2,5-di(2-ethylhexanoylperoxy)hexane, tert-amyl peroxy-2-ethylhexanoate, dibenzoyl peroxide, tert-butyl peroxy-2-ethylhexanoate, tert-butyl peroxydiethylacetate, tert-butyl peroxydiethylisobutyrate, 1,4-di(tert-butylperoxycarbonyl)cyclohexane as an isomer mixture, tert-butyl perisononanoate, 1,1-di(tert-butylperoxy)-3,3,5-trimethylcyclohexane, 1,1-di(tert-butylperoxy)-cyclohexane, methyl isobutyl ketone peroxide, tert-butyl peroxyisopropyl carbonate, 2,2-di-tert-butylperoxy)butane or tert-butyl peroxyacetate; tert-butyl peroxybenzoate, di-tert-amyl peroxide, dicumyl peroxide, the isomeric di(tert-butylperoxyisopropyl)benzenes, 2,5-dimethyl-2,5-di-tert-butylperoxyhexane, tert-butyl cumyl peroxide, 2,5-dimethyl-2,5-di(tert-butylperoxy)-hex-3-yne, di-tert-butyl peroxide, 1,3-diisopropylbenzene monohydroperoxide, cumene hydroperoxide or tert-butyl hydroperoxide; or

dimeric or trimeric ketone peroxides, as described in EP-A 0 813 550.

Particularly suitable peroxides are di-tert-butyl peroxide, tert-butyl peroxypivalate, tert-butyl peroxyisononanoate or dibenzoyl peroxide, or mixtures thereof. An example of an azo compound is azobisisobutyronitrile (AIBN). Free-radical initiators are metered in amounts typical for polymerizations.

Numerous commercially available organic peroxides are admixed with what are called phlegmatizers before being sold, in order to improve their handling properties. Examples of suitable phlegmatizers are white oil or hydrocarbons such as isododecane in particular. Under the conditions of the high-pressure polymerization, such phlegmatizers may have a molecular weight regulating effect. For the purposes of the present invention, the use of molecular weight regulators should be understood as being the additional use of further molecular weight regulators beyond the use of the phlegmatizers.

The proportion of the comonomers (a), (b), and, if desired, (c) in the context of metering typically does not correspond precisely to the proportion of the units in the copolymer (A), since ethylenically unsaturated carboxylic acids are generally incorporated more readily into copolymer (A) than is ethylene.

The comonomers (a), (b), and, if desired, (c) are typically metered together or separately.

The comonomers (a), (b), and, if desired, (c) may be compressed to the polymerization pressure in a compressor. In another embodiment of the method of the invention the comonomers are first brought, by means of a pump, to an increased pressure of, for example, 150 to 400 bar, preferably 200 to 300 bar, and more particularly 260 bar, and thereafter are brought to the actual polymerization pressure using a compressor.

The copolymerization of the comonomers (a), (b), and, if desired, (c) may optionally be carried out in the absence and in the presence of solvents, with mineral oils, white oil, and other solvents, present in the reactor during the polymerization and used for phlegmatizing the free-radical initiator or initiators, not counting as solvents for the purposes of the present invention. Examples of suitable solvents include toluene, isododecane, and the isomers of xylene.

In order to prepare copolymer (A) in an at least partly neutralized form it is possible to mix it with a preferably aqueous solution of one or more basic alkali metal compounds, preferably of one or more hydroxides and/or carbonates and/or hydrogen carbonates of alkali metals, and more particularly with potassium hydroxide or sodium hydroxide.

In one embodiment of the present invention copolymer (A) is mixed with more hydroxide and/or carbonate and/or hydrogen carbonate of alkali metal than is needed for the neutralization of the carboxylic acid groups.

Aqueous formulation used in the coating method of the invention may further comprise preferably

(B) at least one nonionic or anionic surfactant.

Nonionic surfactants are preferably selected from doubly to trigintuply, preferably to decuply, and more preferably triply to heptuply alkoxylated oxo-process and fatty alcohols, and from fluorinated surfactants.

By doubly to decuply, preferably triply to heptuply alkoxylated oxo-process and/or fatty alcohols are meant those compounds in which two to ten, preferably three to seven, mol of alkylene oxide, preferably C₂-C₄ alkylene oxide such as butylene oxide, preferably propylene oxide, and more preferably ethylene oxide, are reacted with one mol of oxo-process and/or fatty alcohol.

Preferred oxo-process alcohols are C₁₁-C₂₁ oxo-process alcohols, more preferably C₁₃-C₁₅ oxo-process alcohols. Preferred fatty alcohols are unbranched, preferably saturated or at most monounsaturated primary C₁₂-C₄₀ alcohols.

Preferred anionic surfactants are ether carboxylates and ether sulfates, more particularly alcohol ether sulfate, lauryl ether sulfate, linear alkylbenzenesulfonates, i.e., benzenesulfonates substituted by linear alkyl radicals, and sodium dodecyl sulfate.

By fluorosurfactants are meant, more particularly acidic phosphoric esters of fluorinated alcohols and mixed acidic phosphoric esters of fluorinated and nonfluorinated alcohols, and also salts of the aforementioned acidic phosphoric esters. Fluorinated alcohols include more particularly n-C₄-C₂₀-alkanols which contain at least one fluorine atom, preferably at least 5 fluorine atoms per molecule. Nonfluorinated alcohols include, more particularly, fluorine-free n-C₄-C₂₀-alkanols.

Very particular preference is given to acidic phosphoric esters of the general formula III

(R^{F}—CH₂CH₂O)ₓP(O)(ONH₄)_{y} III

in which the variables are defined as follows:
RF is selected from F(CF₂CF₂)_{z},
z is an integer in the range from 1 to 9, preferably to 7,
x is 1 or 2,
y is 2 or 1,
and x+y=3,
and acidic phosphoric esters of the general formula IV

(R⁵O)ₓP(O)(ONH₄)_{y} IV

where R⁵ is selected from n-C₄-C₂₀-alkyl, preferably up to C₁₈ alkyl, such as n-butyl, n-pentyl, n-hexyl, n-octyl, n-nonyl, n-decyl, n-undecyl, n-dodecyl, n-tetradecyl, n-hexadecyl, n-octadecyl, and n-eicosyl, for example, more particularly n-decyl, n-undecyl, n-dodecyl, n-tetradecyl, n-hexadecyl, n-octadecyl,
and the other variables are as defined above,

Aqueous formulation used in the coating method of the invention may comprise preferably

(C) at least one defoamer, which in the context of the present invention can also be referred to as foam suppressant or antifoam (C).

Suitable defoamers (C) are selected more particularly from multiply alkoxylated glycerol, such as doubly to vigintuply ethoxylated glycerol, for example, polypropylene oxide, having for example 10 to 50 polypropylene oxide units per molecule, and preferably phosphoric acid tri-C₁-C₆ alkyl esters. In phosphoric acid tri-C₁-C₆ alkyl esters the C₁-C₆ alkyl radicals may be different or, preferably, alike, and they may be unbranched, as for example methyl, ethyl, n-propyl, n-butyl, n-pentyl or n-hexyl, or, preferably, branched, more particularly isopropyl, isobutyl, sec-butyl, iso-pentyl, sec-pentyl, 3-pentyl, isohexyl, sec-hexyl, isoamyl; isobutyl is especially preferred.

One very particularly preferred defoamer (C) is phosphoric acid triisobutyl ester, also called triisobutyl phosphate.

In one embodiment of the present invention the aqueous formulation used in the coating method of the invention may comprise at least one organic amine (D), preferably an ethanolamine such as, for example, monoethanolamine, N,N-diethanolamine, N,N,N-triethanolamine, N-methyldiethanolamine or N,N-dimethyl-N-ethanolamine.

In one embodiment of the present invention the aqueous formulation used in the coating method of the invention may comprise at least one alkali metal salt.

In one embodiment of the present invention the aqueous formulation used in the coating method of the invention may comprise at least one organic solvent (E), preferably an organic solvent which is miscible with water. Particular preference is given to C₁-C₄ alcohols, more particularly ethanol and isopropanol, and also to isobutanol, n-butanol, butyl diglycol (diethylene glycol mono-n-butyl ether), and methanol.

In one embodiment of the present invention the aqueous formulation used in the coating method of the invention may comprise at least one polymer dispersion (F). By polymer dispersion (F) is meant a preferably aqueous dispersion of a carboxyl-functional polymer or copolymer that is different from copolymer (A). Examples of suitable polymers and copolymers include the following: homopolymers and copolymers of (meth)acrylic with 50% to 100% by weight of incorporated (meth)acrylic acid, more particularly acrylic acid homopolymers and copolymers of (meth)acrylic acid with methyl (meth)acrylate or vinylaromatics such as styrene. Also included are polyurethanes which comprise on average at least one carboxyl-functional molecule incorporated per molecule of polyurethane. The incorporated carboxyl-functional molecule is preferably 1,1-dimethylolacetic acid, 1,1-dimethylolbutyric acid or, more preferably, 1,1-dimethylolpropionic acid. Also included is hydroxyacetic acid, which can be incorporated as a stopper.

In one embodiment of the present invention, substantially paraffin-free aqueous formulation used in the coating method of the invention comprises

in the range from 1% to 40%, preferably 5% to 30%, by weight of copolymer (A),
preferably in the range from 0.0001% to 10%, more preferably 0.001% to 8%, by weight of anionic or nonionic surfactant (B),
preferably in the range from 0.01% to 10%, more preferably 0.1% to 8%, by weight of defoamer (C),
in the range from zero to 10%, preferably 0.1% to 8%, by weight of organic amine (D) or alkali metal salt,
in the range from zero to 60%, preferably 0.1% to 20%, by weight of organic solvent (E),
in the range from zero to 10%, preferably 0.1% to 5%, by weight of polymer dispersion (F),
the remainder being preferably water, which may be salt-containing or preferably is desalted, by means for example of distillation or using an ion exchange resin. Amounts in % by weight are based on the entire aqueous formulation used in the coating method of the invention. In connection with polymer dispersion (F), moreover, the amounts in % by weight are based on the solids fraction of the polymer dispersion (F).

The coating method of the invention can be implemented by, for example, spraying the container of glass, polyethylene or polyester that is to be coated. This can be done by using one or more conveying elements to move the containers through a spray mist of aqueous formulation as described above. It is preferred for the whole container of glass, polyethylene or polyester to be wetted with aqueous formulation, in order to achieve an optimum result.

In another version of the present invention, containers of glass, polyethylene or polyester can be dipped into the above-described aqueous formulation.

In another version of the present invention one or more articles, such as one or more cloths, wipes or other textiles, for example, can be wetted with aqueous formulation as described above and used to treat containers of glass, polyethylene or polyester. This version is advisable more particularly for small numbers of glass, polyethylene or polyester containers for treatment.

To effect curing it is possible to carry out thermal treatment, drying for example at 30 to 100° C., or else drying can be carried out in air.

The present invention further provides containers of glass, polyethylene or polyester, coated by the coating method of the invention. Inventive containers of glass, polyethylene or polyester exhibit a significantly lower tendency to become soiled than those containers which have been coated with paraffin. Moreover, inventive containers of glass, polyethylene or polyester exhibit excellent transparency. Even when the substrate containers of glass, polyethylene or polyester already have scratches or relatively small areas of delamination, they look highly transparent after coating in accordance with the invention, and are as if undamaged.

Moreover, inventive containers of glass, polyethylene or polyester can easily be cleaned to remove the coating. Following cleaning, aqueous formulation can be applied again so as to raise the service life and frequency of inventively coated containers of glass, polyester or polyethylene.

In many cases it is possible to observe that containers of glass, polyethylene or polyester coated by the method of the invention and their fingerprints can be cleaned with a dry cloth, for example a fleece, duster, kitchen towel or paper tissue, or with cottonwool, without any need to exert great pressure.

After drying, containers of glass, polyethylene or polyester that have been coated by the method of the invention preferably have a coat thickness in the range from 1 to 100 μm, more preferably 1.5 to 50 μm. In one version, after drying, containers of glass, polyethylene or polyester that have been coated by the method of the invention have a coat thickness in the range from 0.05 to 100 μm, preferably 0.1 to 50 μm. The coat thickness may be determined, for example, by weighing. The coat thickness may also be determined optically, such as by microscope, for example. It is also possible to calculate a coat thickness on the assumption of a quantitative deposition of copolymer (A) and emulsifier (B).

The present invention additionally provides substantially paraffin-free aqueous formulations comprising

(A) at least one acid-functional waxy copolymer selected from
(A1) partially oxidized polyethylene waxes having an acid number in the range from 10 to 100 mg KOH/g, preferably 10 to 50 mg KOH/g, determined in accordance with DIN 53402, and
(A2) copolymers having a melt flow rate (MFR) in the range from 1 to 50 g/10 min, preferably 5 to 20 g/10 min, measured at 160° C. under a load of 325 g in accordance with EN ISO 1133, more preferably 7 to 15 g/10 min, which in copolymerized form comprise
(a) 60 to 88%, preferably 65% to 80%, by weight of ethylene,
(b) 12% to 40%, preferably 20% to 35%, by weight of at least one ethylenically unsaturated carboxylic acid, more particularly (meth)acrylic acid,
   and which is at least partially neutralized with alkali metal or amine, more particularly with potassium or sodium, or with amine, more particularly ammonia or with organic amine such as ω-hydroxyalkylamine, for example, with amounts in % by weight being based on the copolymer (A2) as a whole,
   (B) if desired, at least one nonionic or anionic surfactant,
   (C) if desired, at least one defoamer,
   (D) if desired, at least one organic amine,
   (E) if desired, at least one organic solvent,
   (F) if desired, a polymer dispersion.

Aqueous formulations of the invention are especially suitable for implementing the method of the invention.

In one embodiment of the present invention nonionic surfactant (B) is selected from doubly to trigintuply, preferably triply to heptuply alkoxylated oxo-process and fatty alcohols.

In one embodiment of the present invention anionic surfactant is selected from fluorinated surfactants.

In one embodiment of the present invention defoamer (C) is selected from multiply alkoxylated glycerol, polypropylene oxide, and phosphoric acid tri-C₁-C₆ alkyl esters.

In one embodiment of the present invention defoamer (C) is triisobutyl phosphate.

In one embodiment of the present invention, substantially paraffin-free aqueous formulation of the invention comprises

in the range from 1% to 40%, preferably 5% to 30%, by weight of copolymer (A),
in the range from 0.0001% to 10%, more preferably 0.001% to 5%, by weight of anionic or nonionic surfactant (B),
preferably in the range from 0.01% to 10%, more preferably 0.1% to 8%, by weight of defoamer (C),
preferably in the range from zero to 10%, preferably 0.1% to 8%, by weight of organic amine (D),
in the range from zero to 60%, preferably 0.1% to 20%, by weight of organic solvent (E),
in the range from zero to 10%, preferably 0.1% to 5%, by weight of polymer dispersion (F),
the remainder being preferably water, which may be salt-containing or preferably is desalted, by means for example of distillation or using an ion exchange resin. Amounts in % by weight are based on the entire aqueous formulation of the invention. In connection with polymer dispersion (F), moreover, the amounts in % by weight are based on the solids fraction of the polymer dispersion (F).

Further details on copolymer (A), anionic and/or nonionic surfactants (B), defoamer (C), organic amine (D), organic solvents (E), and polymer dispersion (F) are described above.

In one embodiment of the present invention, aqueous formulations of the invention have a pH in the range from 7 to 14, preferably from 7.5 to 12, and very preferably from 8 to 11.5.

In one embodiment of the present invention, aqueous formulations of the invention have a solids content in the range from 1.0101% to 45% by weight, preferably 3% to 35% by weight.

The present invention further provides a method of preparing aqueous formulations, also referred to below as preparation method of the invention. The preparation method of the invention comprises mixing with one another, in water,

(A) at least one acid-functional waxy copolymer selected from
(A1) partially oxidized polyethylene waxes having an acid number in the range from 10 to 100 mg KOH/g, preferably 15 to 50 mg KOH/g, determined in accordance with DIN 53402, and
(A2) copolymers having a melt flow rate (MFR) in the range from 1 to 50 g/10 min, measured at 160° C. under a load of 325 g in accordance with EN ISO 1133, which in copolymerized form comprise
   (a) 60% to 88% by weight of ethylene,
   (b) 12% to 40% by weight of at least one ethylenically unsaturated carboxylic acid,
   and which are at least partially neutralized with alkali metal or amine,
      (B) if desired, at least one nonionic or anionic surfactant,
      (C) if desired, at least one defoamer,
      (D) if desired, at least one organic amine,
      (E) if desired, at least one organic solvent,
      (F) if desired, a polymer dispersion.

A preferred procedure is to carry out the preparation method of the invention in two steps. In a first step, copolymer (A) is fully or at least partly neutralized, if desired in the presence of nonionic or anionic surfactant (B), in water. In the second step, defoamer (C) and—if no nonionic or anionic surfactant (B) has been added in the first step—at least one nonionic or anionic surfactant (B) as well are added. Where their addition is desired, organic amine (D), polymer dispersion (F), and organic solvent (E) can be added at any point in the preparation method of the invention.

It is preferred to carry out the first step of the preparation method of the invention at a temperature which lies above the melting point of copolymer (A).

In one specific embodiment of the present invention the implementation of the preparation method of the invention starts from one or more of the copolymers (A) described above. Copolymers (A) are placed in a vessel, such as a flask, an autoclave or a tank, for example, and the copolymer or copolymers (A), water, and one or more basic alkali metal compounds, ammonia or organic amine (D), and further constituents if desired, are heated. It is possible to add further constituents, such as nonionic or anionic surfactant (B), for example, the sequence of the addition being arbitrary. If the temperature for implementing the preparation method of the invention is to be above 100° C., it is advantageous to operate under elevated pressure and to select the vessel accordingly. The resultant emulsion is homogenized, as for example by mechanical or pneumatic stirring or by shaking. It is advantageously heated to a temperature above the melting point of the copolymer or copolymers (A). Heating takes place advantageously to a temperature which is at least 10° C., more preferably to a temperature which is at least 30° C., above the melting point of the copolymer or copolymers (A).

Where two or more different copolymers (A) are used, heating takes place to a temperature which is above the melting point of the copolymer (A) that melts at the highest temperature. Where two or more different copolymers (A) are used, it is advantageous to carry out heating to a temperature which is at least 10° C. above the melting point of the copolymer (A) that melts at the highest temperature. Where two or more different copolymers (A) are used, it is particularly advantageous to carry out heating to a temperature which is at least 30° C. above the melting point of the copolymer (A) that melts at the highest temperature.

Subsequently the aqueous formulation thus prepared is allowed to cool, and preferably it is cooled. Before, during or after cooling, it is possible to add at least one nonionic or anionic surfactant (B) or defoamer (C) or polymer dispersion (F), if this is desired but has not yet taken place.

The aqueous formulations prepared by the preparation method of the invention feature high stability on storage and can be used effectively in the coating method of the invention as described above.

The invention is illustrated by means of working examples.

### Preparation of Copolymer (A2.1)

Ethylene and methacrylic acid were copolymerized in a high-pressure autoclave of the kind described in the literature (M. Buback et al., Chem. Ing, Tech. 1994, 66, 510). This was done by continuously feeding ethylene (12.0 kg/h) into the high-pressure autoclave under the reaction pressure of 1700 bar. Separately from this, 0.71 kg/h (0.72 l/h) of methacrylic acid was first compressed to an intermediate pressure of 260 bar using a compressor, and then fed continuously into the high-pressure autoclave with the aid of a further compressor, under the reaction pressure of 1700 bar. The maximum internal temperature of the high-pressure reactor was approximately 220° C. 2.9 kg/h of copolymer (A2.1) were obtained, corresponding to an ethylene conversion of 18%, with the analytical data apparent below.

Ethylene content: 72.8% by weight, methacrylic acid content 27.2% by weight, acid number: 170 mg KOH/g, melting temperature: 79.3° C., density: 0.961 g/cm³.

The MFR of copolymer (A2.1) was 10.3 g/10 min, determined under a load of 325 g at a temperature of 160° C.

The ethylene and methacrylic acid contents of copolymer (A2.1) were determined by NMR spectroscopy and by titration (acid number). The acid number of copolymer (A2.1) was determined by titrimetry in accordance with DIN 53402. The KOH consumption corresponds to the methacrylic acid content of the copolymer (A2.1).

The density was determined in accordance with DIN 53479. The melting range was determined by means of DSC (differential scanning calorimetry, differential thermal analysis) in accordance with DIN 51007.

### 2. Preparation of Inventive Formulations

A 2 liter autoclave with anchor stirrer was charged with 206.8 g of copolymer (A2.1). 36.3 g of KOH were added and the batch was made up to one liter with distilled water and heated to 98° C. with stirring. After stirring at 98° C. for 180 minutes, the batch was cooled to room temperature over the course of 15 minutes. This gave a 21% by weight emulsion of copolymer (A2.1), which was neutralized with KOH.

In a stirring vessel, the amounts of emulsion of copolymer (A2.1) indicated in table 1 were mixed, and also distilled water, nonionic or anionic surfactant (B), defoamer (C.1) and, if desired, diethanolamine D.1) were added. This gave the inventive formulations F-1 to F-8.

TABLE 1
Preparation of inventive formulations F-1 to F-8

| | Emulsion of | | | | | |
|---|---|---|---|---|---|---|
| | copolymer | | | | Diethanolamine | |
| | (A2.1), | (B.1) | (B.2) | Defoamer | (D.1) | Water |
| No. | [g] | [g] | [g] | (C.1 )[g] | [g] | [g] |
| F-1 | 400 | — | 15 | 5 | — | 580 |
| F-2 | 400 | 10 | — | 5 | — | 585 |
| F-3 | 400 | 10 | 15 | 5 | — | 570 |
| F-4 | 400 | — | 15 | 5 | 10 | 575 |
| F-5 | 400 | 10 | — | 5 | 10 | 575 |
| F-6 | 200 | — | 15 | 5 | — | 780 |
| F-7 | 400 | 10 | — | 5 | 10 | 575 |
| F-8 | 400 | 20 | — | 5 | 10 | 565 |
| F-9 | 400 | 10 | — | 5 | 10 | 375 |
| F-10 | 400 | 10 | — | 5 | 10 | — |

Abbreviations:
(B.1): C₁₃-C₁₅ oxo-process alcohol, ethoxylated with 3 mol of ethylene oxide/mol of C₁₃-C₁₅ oxo-process alcohol
(B.2): 40% strength by weight solution, diluted 99:1 with water, of a 1:1 mixture (weight fractions) of F(CF₂CF₂)₅—CH₂CH₂O)—P(O)(ONH₄)₂ and[F(CF₂CF₂)₅—CH₂CH₂O]₂P(O)(ONH₄) in water/isopropanol (weight fractions: 3:1)
(Note:
99 parts by weight of water, 1 part by weight of the 40% by weight solution of fluorosurfactant)
(C.1): Triisobutyl phosphate

Inventive formulation F-10 additionally contained 200 g of butyl diglycol (diethylene glycol mono-n-butyl ether).

Inventive formulation F-11 additionally contained 575 g of butyl diglycol.

Comparative formulation C-F-9 was prepared by mixing 400 g of dispersion D1 from WO 2004/108601 with 10 g of (B.2), 5 g of defoamer (C.1), and 585 g of distilled water.

### 3. Inventive Coating of Containers of Glass, Polyethylene or Polyester

Using a soft cloth, an inventive formulation F-1 to F-10 was applied to a 1 liter bottle of scratched glass (about 2 scratches/cm², average scratch length: 5 mm) and left to dry in air. This gave inventively coated glass bottles. The thickness of the coating was on average 3 to 15 μm. The inventively coated glass bottles had a pleasing appearance and were completely transparent, so that the contents were readily visible. In addition, paper labels were easy to adhere.

Using a soft cloth, an inventive formulation F-1 to F-10 was applied to a 0.5 liter bottle of scratched polyester (about 2 scratches/cm², average scratch length: 3 mm) and left to dry in air. This gave inventively coated polyester bottles. The thickness of the coating was on average 3 to 15 μm. The inventively coated polyester bottles had a pleasing appearance and were completely transparent, so that the contents were readily visible. In addition, paper and plastic labels were easy to adhere.

1-17. (canceled)

18. A method of coating a container made of glass, polyethylene or polyester, which comprises treating it with a substantially paraffin-free aqueous formulation which comprises
(A) at least one acid-functional waxy copolymer selected from
(A1) partially oxidized polyethylene waxes having an acid number in the range from 10 to 100 mg KOH/g, determined in accordance with DIN 53402, and
(A2) copolymers having a melt flow rate (MFR) in the range from 1 to 50 g/10 min, measured at 160° C. under a load of 325 g in accordance with EN ISO 1133, which in copolymerized form comprise
(a) 60% to 88% by weight of ethylene,
(b) 12% to 40% by weight of at least one ethylenically unsaturated carboxylic acid,
and which are at least partially neutralized with alkali metal or amine,
(B) if desired, at least one nonionic or anionic surfactant,
(C) if desired, at least one defoamer,
(D) if desired, at least one organic amine,
(E) if desired, at least one organic solvent.

19. The method according to claim 18, wherein the outer surface of the container is coated.

20. The method according to claim 18, wherein nonionic surfactant (B) is selected from triply to heptuply alkoxylated oxo-process and fatty alcohols.

21. The method according to claim 18, wherein anionic surfactant (B) is selected from acidic phosphoric esters of fluorinated alcohols.

22. The method according to claim 18, wherein the treating is performed as dipping or spraying.

23. The method according to claim 18, wherein ethylenically unsaturated carboxylic acid (b) is (meth)acrylic acid.

24. The method according to claim 18, wherein defoamer (C) is selected from multiply alkoxylated glycerol, polypropylene oxide, and phosphoric acid tri-C₁-C₆ alkyl esters.

25. The method according to claim 18, wherein defoamer (C) is triisobutyl phosphate.

26. A container coated by a method according to claim 18.

27. The container according to claim 26, which is a bottle.

28. A substantially paraffin-free aqueous formulation comprising
(A) at least one acid-functional waxy copolymer selected from
(A1) partially oxidized polyethylene waxes having an acid number in the range from 10 to 100 mg KOH/g, determined in accordance with DIN 53402, and
(A2) copolymers having a melt flow rate (MFR) in the range from 1 to 50 g/10 min, measured at 160° C. under a load of 325 g in accordance with EN ISO 1133, which in copolymerized form comprise
(a) 60% to 88% by weight of ethylene,
(b) 12% to 40% by weight of at least one ethylenically unsaturated carboxylic acid,
and which are at least partially neutralized with alkali metal or amine,
(B) at least one nonionic or anionic surfactant,
(C) at least one defoamer,
(D) if desired at least one organic amine,
(E) if desired at least one organic solvent.

29. The aqueous formulation according to claim 27, wherein nonionic surfactant (B) is selected from triply to heptuply alkoxylated oxo-process and fatty alcohols.

30. The aqueous formulation according to claim 27, wherein anionic surfactant is selected from fluorinated surfactants.

31. The aqueous formulation according to claim 27, wherein ethylenically unsaturated carboxylic acid (b) is (meth)acrylic acid.

32. The aqueous formulation according to claim 27, wherein defoamer (C) is selected from multiply alkoxylated glycerol, polypropylene oxide, and phosphoric acid tri-C₁-C₆ alkyl esters.

33. The aqueous formulation according to claim 27, wherein defoamer (C) is selected from triisobutyl phosphate.

34. A method of preparing an aqueous formulation according to claim 27, which comprises mixing together in water
(A) at least one acid-functional waxy copolymer selected from
(A1) partially oxidized polyethylene waxes having an acid number in the range from 10 to 100 mg KOH/g, determined in accordance with DIN 53402, and
(A2) copolymers having a melt flow rate (MFR) in the range from 1 to 50 g/10 min, measured at 160° C. under a load of 325 g in accordance with EN ISO 1133, which in copolymerized form comprise
(a) 60% to 88% by weight of ethylene,
(b) 12% to 40% by weight of at least one ethylenically unsaturated carboxylic acid,
and which are at least partially neutralized with alkali metal,
(B) at least one nonionic or anionic surfactant,
(C) at least one defoamer,
(D) if desired at least one organic amine,
(E) if desired at least one organic solvent.
